(19) United States
(12) Patent Application Publication
(10) Pub. No.: US 2025/0012974 A1
(43) Pub. Date: Jan. 9, 2025

(54) SYSTEM AND METHOD FOR A SEGMENTED IMAGE-RELAY FIBER (SIRF)

(71) Applicant: University of Utah Research Foundation, Salt Lake City, UT (US)

(72) Inventor: Rajesh MENON, Salt Lake City, UT (US)

(21) Appl. No.: 18/765,612

(22) Filed: Jul. 8, 2024

Related U.S. Application Data
(60) Provisional application No. 63/512,397, filed on Jul. 7, 2023.

(51) Int. Cl. G02B 6/26

(52) U.S. Cl. CPC G02B 6/262

(57) ABSTRACT

A segmented image-relay fiber can include concatenating image-relay fiber segments. Each segment can include, or consist of, an optical fiber and an imaging lens. Each segment can accurately reproduce (e.g., with little to no losses or distortion of the image) a light intensity distribution in its input plane at its output plane, while reducing the distortion of the image that occurs in many typical fiber optic image transfers. This approach can be used for a variety of applications, such as micro-endoscopy and communication transmissions that can benefit from spatially preserved information. The recorded images can also be analyzed or processed using various computational methods, including machine learning (e.g., a trained algorithm), to enhance performance.

### CROSS REFERENCE TO RELATED APPLICATIONS

This application claims priority to U.S. Provisional Patent Application No. 63/512,397, filed Jul. 7, 2023 which is incorporated herein by reference.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION BY REFERENCE STATEMENT

Not applicable.

### BACKGROUND

Information transfer through an optical fiber (sometimes referred to as a fiber or optical fiber in this document) typically does not utilize the spatial modes within the fiber since an image at an input plane of the fiber can lead to a distorted image at an output plane because there is an unpredictable mixing of spatial modes within the fiber. Multi-core fibers or fiber bundles are often used to solve this problem. In the former, each core of the fiber transmits one pixel of the image. In the latter, each fiber transmits one pixel of the image. This significantly limits the spatial resolution to the center-to-center spacing of the core or the fiber. Furthermore, these approaches can cause dead space between the pixels, which can lead to image artifacts. In addition, these solutions suffer from other disadvantages, including reduced spatial resolution because both multi-core fibers and fiber bundles have a larger core diameter than single-mode fibers, which limits the spatial resolution of the image.

Further, a multi-core fiber or a fiber bundle typically has a lower numerical aperture (NA) compared to a single-core fiber, which reduces the light collection efficiency and the imaging resolution. Multi-core fibers or fiber bundles can also be challenging to align and focus compared to single-core fibers, which can increase the complexity of the imaging system and reduce its reliability. Multi-core fibers and fiber bundles can produce ghosting artifacts, which are images of the same object that appear in different locations in the field of view. Multi-core fibers and fiber bundles can exhibit inter-core crosstalk, which is the mixing of light from different cores. This can reduce the image quality and make it difficult to distinguish between different objects in the field of view. Multi-core fibers and fiber bundles also have a limited field of view, which is the area of the object that can be imaged. Multi-core fibers and fiber bundles are typically more expensive than single-mode fibers. When using a multi-core fiber or fiber bundle, the captured light signals need to be reconstructed to form the final image. This process can be computationally complex and may require sophisticated algorithms and calibration procedures. It can add complexity to the imaging system and increase the computational overhead, potentially leading to longer processing times. Many of these solutions also suffer from chromatic aberrations due to material dispersion in the fiber.

### SUMMARY

This invention relates to a new approach to high-resolution image transfer through a fiber using concatenated segments. Each segment reproduces a light intensity distribution in its input plane at its output plane, while reducing the distortion of the image that occurs in many typical fiber optic image transfers. Such a fiber can be used for a variety of applications that can benefit from reduced distortion and higher resolution imaging, such as micro-endoscopy and communication transmissions that can benefit from spatially preserved information. The recorded images can be combined with computational methods including machine learning to enhance performance.

An image-relay fiber segment is disclosed. In some examples, the image-relay fiber segment includes a first optical fiber subsegment, a second optical fiber subsegment optically coupled with the first fiber subsegment, and an imaging lens optically coupled between the first optical fiber subsegment and the second optical fiber subsegment. The imaging lens can be configured to relay a light intensity distribution at an input plane of the image-relay fiber segment to an output plane of the image-relay fiber segment. In some cases, the input plane and the output plane are at opposites ends of the image-relay fiber segment.

In some examples, the imaging lens comprises one or more of a diffractive lens, a multi-level diffractive lens, a metalens, a flat-lens, and a refractive lens. The imaging lens can be made from one or more of germanium, glass, polymer, fused silica, titanium dioxide, sapphire, and any dielectric material that is substantially transparent to the incoming light.

In some examples, the first optical fiber subsegment and the second optical fiber subsegment comprise separate optical fibers; and the imaging lens is: optically coupled with an end of the first optical fiber subsegment that is opposite the input plane; and optically coupled with an end of the second optical fiber subsegment that is opposite the output plane.

In some additional examples, the first optical fiber subsegment and the second optical fiber subsegment comprise subsegments of a single optical fiber; and the imaging lens is formed in the image-relay fiber segment, between the first optical fiber subsegment and the second optical fiber subsegment, at approximately a center plane of the image-relay fiber segment. In some cases, a distance from the input plane to the imaging lens is an object distance (OD), a distance from the imaging lens to the output plane is an image distance (ID), and the imaging lens is configured to have a focal length (FL) such that the sum of 1/OD and 1/ID is: about 1/FL, from about 98 percent of 1/FL to about 102 percent of 1/FL, from about 95 percent of 1/FL to about 105 percent of 1/FL, or substantially equal to 1/FL.

In some examples, the imaging lens includes a high-refractive-index (HRI) coating. In some non-limiting examples, the HRI coating comprises one or more of: a polymer glass; silicon nitride; aluminum nitride; spin-on glass; and a flowable polymer. Further, in some cases, the HRI coating is planarized. Regardless of the material, the coating can have a refractive index that is different than that of the lens material, and the coating material can be substantially transparent to the incoming light.

In some further examples, the image-relay fiber segment has a length of: about 1 micrometer (μm), about 10 μm, about 50 μm, from about 10 μm to about 100 μm, or from about 100 μm to about 1000 μm.

In some examples, the image-relay fiber segment includes a pre-segment optic configured to focus light at an input plane of the first optical fiber subsegment. Further, pre-segment optics can also include spectral filters, polarization filters, light conditioners/homogenizers, splitters, and the like. Non-limiting examples of the pre-segment include one or more of: an optical lens; a flat lens; and an optical fiber.

A segmented image-relay fiber is also disclosed. In some examples, the segmented image-relay fiber includes a plurality of image-relay fiber segments. The respective output planes at an output end of the image-relay fiber segment are optically coupled with an input plane of an adjacent image-relay fiber segment. In some cases, the respective output planes are optically coupled with the input planes of the adjacent image-relay fiber segments using one or more of: optical glue; laser welding; spring joints; and a sleeve. In some further cases, the imaging lens of the image-relay fiber segment and the imaging lens of the other image-relay fiber segment are: a same lens type; or a different lens type.

A method of forming an image-relay fiber segment is also disclosed. The method includes: optically coupling an imaging lens between a first optical fiber subsegment of the image-relay fiber segment and a second optical fiber subsegment of the image-relay fiber segment. The imaging lens is configured to relay a light intensity distribution at an input plane of the image-relay fiber segment to an output plane of the image-relay fiber segment. In some examples, optically coupling comprises one or more of: coupling with optical glue; laser welding; coupling with spring joints; and coupling with a sleeve.

In some examples of the method, the first optical fiber subsegment and the second optical fiber subsegment comprise separate optical fibers, and the method further comprises: forming the imaging lens on the output plane of the first optical fiber subsegment; and optically coupling the imaging lens with the input plane of the second optical fiber subsegment.

In other examples, the first optical fiber subsegment and the second optical fiber subsegment comprise subsegments of a single optical fiber, and the method further comprises: forming the imaging lens in the image-relay fiber segment, between the first optical fiber subsegment and the second optical fiber subsegment, at approximately a center plane of the image-relay fiber segment.

In further examples, the method also includes forming the imaging lens using one or more of: a lithography technique; a diamond-turning technique; an injection molding technique; a nanoimprinting technique; and a microprinting technique. Non-limiting examples of the lithography technique include one or more of: optical lithography; optical-projection lithography; two-photon lithography; multi-photon lithography; optical-grayscale lithography; scanning-electron-beam lithography; and focused-ion-beam lithography.

In additional examples, the image-relay fiber segment includes an input plane that is at an end of the first optical fiber subsegment that is opposite the output plane of the first optical fiber subsegment and an output plane that is at an end of the second optical fiber subsegment that is opposite the input plane of the second optical fiber subsegment, In this example, the method further comprises forming the imaging lens such that: the imaging lens is configured to relay a light intensity distribution at the input plane of the image-relay fiber segment to the output plane of the image-relay fiber segment. The method also includes forming the imaging lens such that: a distance from the input plane of the image-relay fiber segment to the imaging lens is an object distance (OD), a distance from the imaging lens to the output plane of the image-relay fiber segment is an image distance (ID), and the imaging lens is configured to have a focal length (FL) such that the sum of 1/OD and 1/ID is: about 1/FL, from about 98 percent of 1/FL to about 102 percent of 1/FL, from about 95 percent of 1/FL to about 105 percent of 1/FL, or substantially equal to 1/FL.

In further examples, the method also includes forming a high-refractive-index (HRI) coating over an output end of the imaging lens, and optically coupling an input plane of a second optical fiber subsegment with the imaging lens further comprises optically coupling the input plane of the second optical fiber subsegment with the HRI coating of the imaging lens. Optionally, the method can include planarizing the HRI coating after the HRI coating is formed.

The method can also include forming a plurality of image-relay fiber segments and optically coupling the plurality of image-relay fiber segments together such that the output plane of each image-relay fiber segment is optically coupled to the input plane of a next image-relay fiber segment. In some cases, the method can also include optically coupling an image repeater between one or more of the coupled image-relay fiber segments.

A segmented image-relay fiber is also disclosed. The segmented image-relay fiber includes a first image-relay fiber segment and a plurality of other image-relay fiber segments. In some examples, the first image-relay fiber segment and each image-relay fiber segment of the plurality of image-relay fiber segments include: a first optical fiber subsegment; a second optical fiber subsegment; an input plane at a first end of the first optical fiber subsegment; and an output plane at a second end of the second optical fiber subsegment. wherein the input plane and the output plane are at opposites ends of the image-relay fiber segment; and an imaging lens optically coupled between the first optical fiber subsegment and the second optical fiber subsegment and configured to relay a light intensity distribution at the input plane of the image-relay fiber segment to the output plane of the image-relay fiber segment. The image-relay fiber segments of the plurality of image-relay fiber segments are optically coupled together such that the output plane of each image-relay fiber segment of the plurality of image-relay fiber segments is optically coupled to the input plane of a next image-relay fiber segment of the plurality of image-relay fiber segments; and the output plane of the first image-relay fiber segment is optically coupled to the input plane of the optically coupled plurality of image-relay fiber segments.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1A is a schematic of an example image-relay fiber (IRF) segment, including optical fiber subsegments and an imaging lens.

FIG. 1B illustrates another example implementation of the IRF segment of FIG. 1A in which the optical fiber subsegments comprise separate optical fibers.

FIG. 1C illustrates another example implementation of the IRF segment of FIG. 1A in which the optical fiber subsegments comprise subsegments of a single optical fiber.

FIG. 2A illustrates several example implementations of the imaging lens of FIGS. 1A-1C.

FIG. 2B illustrates the example imaging lens implementations of FIG. 2A with a high-refractive-index (HRI) coating.

FIG. 3 illustrates another example IRF segment that includes a pre-segment that can be configured to focus light at an input plane of the IRF segment.

FIG. 4A illustrates an example segmented image-relay fiber (SIRF) that includes a plurality of optically coupled image-relay fiber (IRF) segments.

FIG. 4B illustrates an example SIRF in a non-linear or bended condition.

FIG. 5 is a flowchart illustrating an example method of forming an IRF segment that can be used in a SIRF.

FIG. 6 illustrates example techniques for forming a high-refractive-index (HRI) coating over an output end of an imaging lens.

FIG. 7 is a flowchart illustrating an example method of forming a SIRF.

FIG. 8A illustrates aspects of a micro-endoscopy technology that uses the techniques described in this document, with reference to FIG. 1A through FIG. 7, including IRF segments and SIRFs

FIG. 8B is a cross-section of an IRF of FIG. 8A highlighting FOV diameter and probe diameter.

FIG. 8C is a cross-section of an IRF of FIG. 8A overlaid with several PSF.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “a lens” includes reference to one or more of such features and reference to “exposing” refers to one or more of such steps.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility and imprecision associated with a given term, metric or value. The degree of flexibility for a particular variable can be readily determined by one skilled in the art. However, unless otherwise enunciated, the term “about”0 generally connotes flexibility of less than 2%, and most often less than 1%, and in some cases less than 0.01%.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, or combinations of each.

As used herein, the term “optically coupled” refers to methods of mechanically joining optically conductive materials in a manner that preserves most or all of optical transmission across an interface between coupled elements. Non-limiting examples of “optically coupled” include coupling with optical glue, laser welding, coupling with spring joints, and coupling with a sleeve.

As used herein, the term “fiber” can include single-or multi-mode optical fibers which allow transmission of light at a desired wavelength, or range of wavelengths, through an internal lumen of the fiber from an input end to an opposite output end.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Transferring information (such as image data) through multi-mode optical fiber typically does not utilize the spatial modes within the fiber. Standard optical fiber can cause the image at the output plane to be distorted (e.g., because of mixing of spatial modes within a fiber). Some solutions, including multi-core fibers or fiber bundles, can help with distortion, but have problems of their own. In multi-core fiber, each core transmits one pixel of the image and in fiber bundles, each fiber transmits one pixel of the image. These limitations can reduce the spatial resolution to the center-to-center spacing of the core or the fiber. These approaches can also have dead space between the pixels, which can generate unwanted image artifacts. Other disadvantages to these solutions include reduced spatial resolution because both multi-core fibers and fiber bundles have a larger core diameter than single-mode fibers.

The disclosed invention describes a technology for high-resolution image transfer through a fiber using concatenated segments. Each segment can accurately reproduce (e.g., with little to no losses or distortion of the image) a light intensity distribution in its input plane at its output plane, while reducing the distortion of the image that occurs in many typical fiber optic image transfers. By accurately relaying the light intensity distribution, at least some of the spatial information in the image is preserved (e.g., the “spatial distribution” of the light intensity). Because the relayed image is nearly identical to the input image, the spatial information is largely preserved whether it is spectral, polarization, intensity, and so forth. Depending on the choice of materials, type of optical coupling, dimensions, and other factors, the relayed image can have a loss in intensity/brightness, sharpness/contrast. In some cases, the loss can be within 5% of the input image, and in some cases within 1%, and in other cases within 0.5%. In some cases, the device acts as a low-pass filter to the object which reduces brightness (e.g. transmission loss) and also loses high spatial frequency information (e.g. loss of contrast/sharpness).

The distance from the input plane to the lens is called the object distance and that from the lens to the output plane is called the image distance. The lens is designed to obey the equation: 1/(image-distance)+1/(object-distance)=1/(focal-length). In addition, the lens can be designed to correct for off-axis aberrations, which can contribute to a large field-of-view, as well as correct for chromatic aberrations, which can provide broadband imaging performance.

This approach can be used for a variety of applications, such as micro-endoscopy and communication transmissions that can benefit from spatially preserved information. The recorded images can also be analyzed or processed using various computational methods, including machine learning (e.g., a trained algorithm), to enhance performance.

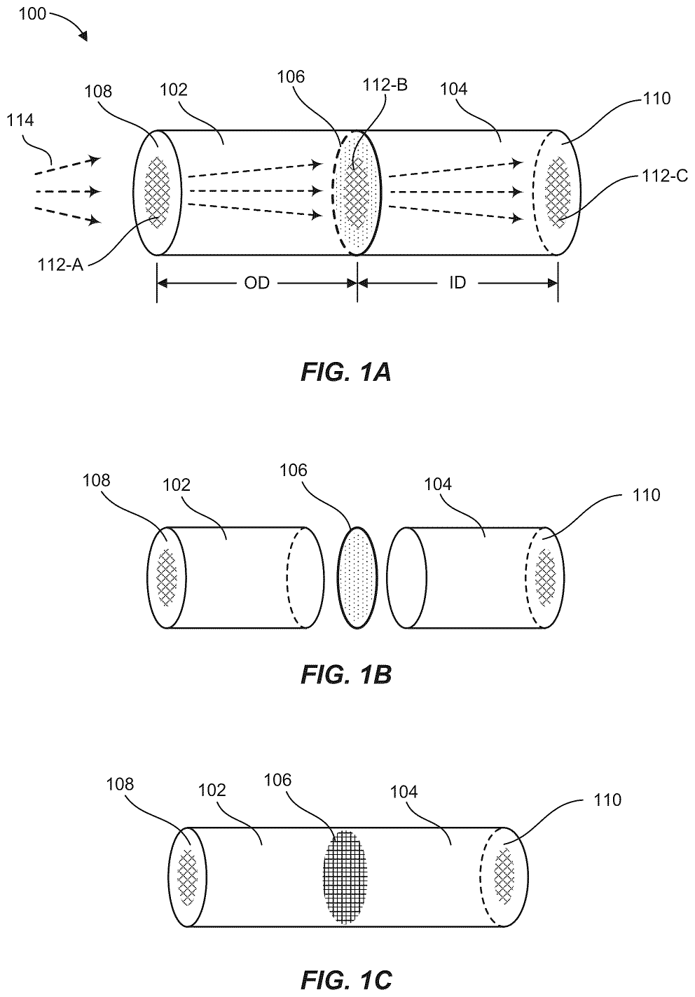

FIG. 1A illustrates an example image-relay fiber (IRF) segment 100 (also referred to as the IRF segment 100). The example IRF segment 100 includes a first optical fiber subsegment 102, a second optical fiber subsegment 104, and an imaging lens 106. The imaging lens 106 can be oriented between the first optical fiber subsegment 102 and the second optical fiber subsegment 104. The first optical fiber subsegment 102 and the second optical fiber subsegment 104 can be made from any of a variety of suitable optical fiber materials. Non-limiting examples of suitable optical fiber materials can include a glass, a silica or doped silica formulation, germanium, a plastic, a combination of materials, and so forth. However, any material that is substantially transparent to the light can be used. Non-limiting examples can include fused silica, polymers (polycarbonate, PET, PMMA, Polystyrene, acrylics, polyimides, etc.), sapphire, titanium dioxide, ITO, etc. For IR wavelengths, silicon, Germanium, ZnSe, ZnS, chalcogenide glasses, etc. can be used, for example. In some example implementations, the IRF segment 100 includes an input plane 108 at one end and an output plane 110 at another end, opposite the input plane 108. The fiber (including subsegments) can be formed as a solid along the light propagation pathways; however, in some cases the fiber can have an interior void (e.g. lumen). In either case, the materials are chosen such that light passes through with minimal losses. Further, different types of fibers can be used including, but not limited to, hollow fibers, holey fibers, photonic-crystal fibers, also applicable to multi-core fibers and fiber bundles. In multi-core fibers and fiber bundles, a lens can be placed in each of the constituent core/fiber. Alternatively, a single lens can be used for multiple cores or fiber sub-bundles (or fiber whole bundles).

In example implementations, the second optical fiber subsegment 104 can be optically coupled with the first fiber subsegment 102. For example, the imaging lens 106 can be optically coupled between the first optical fiber subsegment 102 and the second optical fiber subsegment 104.

FIG. 1B illustrates another example implementation of the IRF segment 100 in which the first optical fiber subsegment 102 and the second optical fiber subsegment 104 comprise separate optical fibers. In the example of FIG. 1B, the imaging lens 106 can be optically coupled with (or formed on) an end of the first optical fiber subsegment 102 that is opposite the input plane 108. The lens 106 (and thus, the first optical fiber subsegment 102) can be optically coupled with an end of the second optical fiber subsegment 104 that is opposite the output plane 110. In other examples, the imaging lens 106 can be optically coupled with (or formed on) an end of the second optical fiber subsegment 104 that is opposite the output plane 110. The lens 106 (and thus, the second optical fiber subsegment 104) can then be optically coupled with the end of the first optical fiber subsegment 102 that is opposite the input plane 108.

In the example of FIG. 1B, the imaging lens 106 is shown separate from both the first optical fiber subsegment 102 and the second optical fiber subsegment 104 to illustrate that the lens 106 is a separate component that can be optically coupled with, formed on, or attached to, either the first optical fiber subsegment 102 or the second optical fiber subsegment 104. Techniques that can be used for the attachment or optical coupling include, by way of non-limiting example, using an optical (transparent) glue, a laser welding technique, a spring joint, a sleeve (e.g., a shrink-wrap tube), or a combination of one or more of these techniques. Any joining method can be used that does not degrade the light transmission between segments. It some cases, the joining can also maintain flexibility such that segments can move/bend relative to one another.

FIG. 1C illustrates yet another example implementation of the IRF segment 100 in which the first optical fiber subsegment 102 and the second optical fiber subsegment 104 comprise subsegments of a single optical fiber (e.g. are regions of the IRF segment 100). In the example of FIG. 1C, the imaging lens 106 can be formed directly within the IRF segment 100, between the first optical fiber subsegment 102 and the second optical fiber subsegment 104 (e.g., “inside” the fiber). In some cases, the imaging lens 106 can be formed at approximately a center plane of the IRF segment 100. Various techniques can be used to form the imaging lens 106 in the IRF segment 100. Non-limiting examples of suitable techniques include laser etching or printing, single fiber optical-projection lithography, two-2-photon lithography, multi-photon lithography, optical-grayscale lithography, scanning-electron-beam lithography, focused-ion-beam lithography, diamond turning, 3D printing, and combinations of techniques. Any method that can be used to create fine features (e.g. below 10 μm) over the face of the fiber or on a separate wafer/surface can be used.

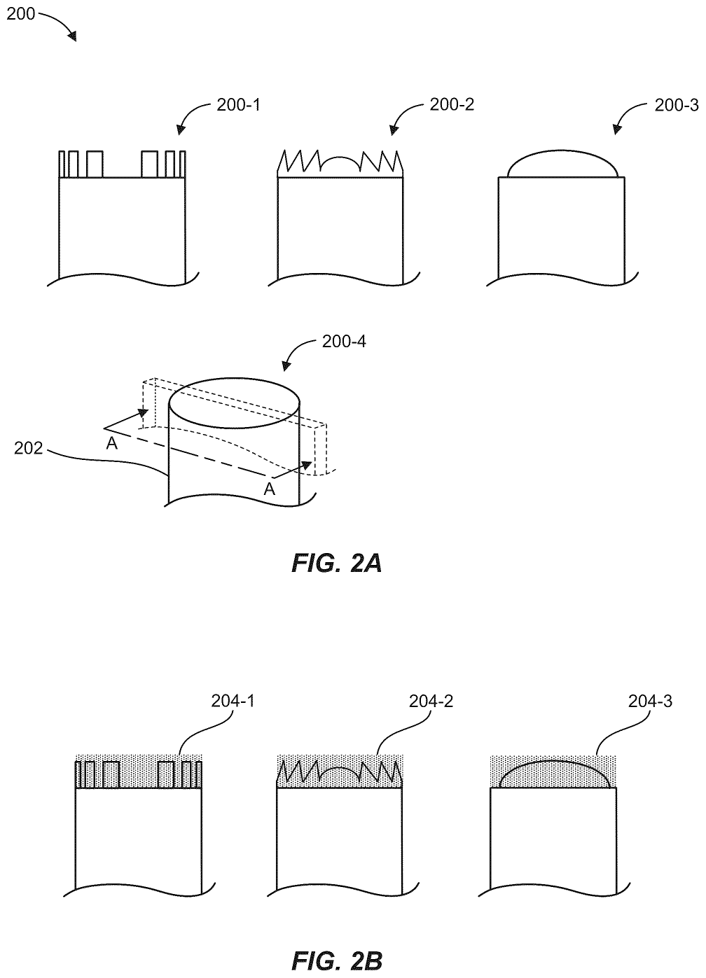

The following paragraphs (along with FIGS. 2A through 8) describe several additional features and options that can be used with the example implementations of the IRF segment 100 as described with reference to FIGS. 1A-1C. In some examples, features from one or more of FIGS. 1A-1C may be included in descriptions associated with other figures. While the examples may be described separately, entire examples and/or particular features of the examples may be combined, mixed, duplicated, or deleted to form other example implementations.

In some example implementations, the imaging lens 106 can be configured to relay a light intensity distribution 112 at the input plane 108 of the IRF segment 100 to an output plane 110 of the IRF segment 100. For example, as shown in FIG. 1A, a light intensity distribution 112-A (depicted as a cross-hatched area at the input plane 108) is received at the imagining lens 106 as a light intensity distribution 112-B and reproduced as light intensity distribution 112-C at the output plane 110. By relaying the light intensity distribution, at least some of the spatial information in the image is preserved. The light intensity distribution 112 can be generated by, for example, light rays 114 that are incident on the input plane 110 (e.g., light reflected from an object to be imaged or from another light source).

In some implementations, the imaging lens 106 can be made from a variety of suitable materials. Material selection for the imaging lens 106 can be based on various factors. For example, the transparency of the material to the light source wavelength (e.g., infra-red, visible, and so forth). Appropriate material selection can also be related to the light transmission efficiency of the lens material. Transmission will typically be attenuated at least a small amount each time light passes through one of the lenses because no lens material is perfectly transmissive. Thus, by using materials that have a higher transmission efficiency, designers can reduce total losses through the whole fiber (e.g., losses will accumulate over a large number of lenses). Non-limiting examples of lens materials include glasses, silicas, doped silicas, germanium, and materials listed previously.

The imaging lens 106 can be any of a variety of types of lenses. Non-limiting examples of lenses include diffractive lenses, multi-level diffractive lenses, metalenses (e.g., diffractive binary lenses), flat-lenses, and refractive lenses. In some cases, combinations of different types of lenses may be implemented. For instance, a surface (spherical, aspherical, and so forth) on a refractive lens can be modified using nanostructures to correct for aberrations in the surface.

Consider FIG. 2A, which illustrates several example implementations 200 of the imaging lens 106 of FIGS. 1A-1C (e.g., example implementations 200-1, 200-2, and 200-3). In FIG. 2A, each example implementation 200-n is shown as a cross-section slice A-A (as shown by example implementation 200-4) of a lens that is attached to an end of an optical fiber 202. Specifically, example implementation 200-1 illustrates a diffractive binary lens (metalens), example implementation 200-2 illustrates a multi-level diffractive lens (blazed lens), and example implementation 200-3 illustrates a refractive lens. As noted above, the imaging lens 106 can be made in a variety of ways, including being formed inside the IRF segment 100 (using the abovementioned techniques), by forming a discrete lens to optically couple with the subsegments 102 and 104 of the IRF segment 100, or by forming it on and end of one of the subsegments 102 or 104.

Non-limiting examples of techniques for making the imaging lens 106 as a discrete component or for forming it on an end of a subsegment include various lithography techniques, including one or more of optical lithography, optical-projection lithography, two-2-photon lithography, multi-photon lithography, optical grayscale lithography, scanning electron-beam lithography, and focused ion-beam lithography. Other example techniques can include, diamond-turning techniques, injection molding techniques, nanoimprinting techniques, and microprinting techniques.

In some example implementations, the imaging lens 106 can includes a high-refractive-index (HRI) coating 204. The HRI coating 204 can help preserve lens function when the imaging lens 106 is coupled with one or both of the optical fiber subsegments 102 and 104. For example, in some cases, a surface of the lens 106 may not be flat or planar. In such examples, coupling the lens 106 with the subsegments 102 and 104 may damage the lens, which may in turn reduce the transmissive efficiency of the lens 106.

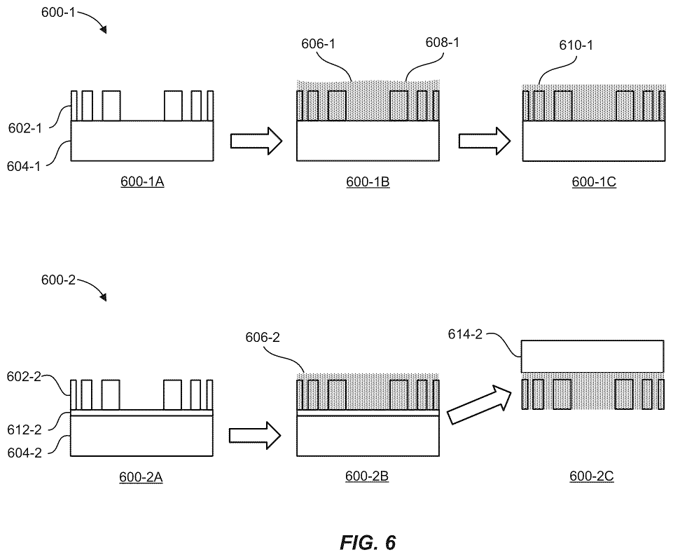

FIG. 2B illustrates the example implementations of FIG. 2A with the HRI coating 204. The HRI coating 204 can be made from various materials. Non-limiting examples of suitable materials include polymer glass, silicon nitride, aluminum nitride, spin-on glass, and flowable polymers. In some implementations, the HRI coating 204 can be planarized. For example, some fabrication techniques may result in an uneven surface that may degrade optical performance when joined to another fiber segment. Non-limiting examples of suitable techniques that can be used to form the HRI coating include dip coating, spin coating, evaporation, sputtering, chemical vapor deposition, plasma-enhanced chemical vapor deposition, atomic-layer deposition, etc. Additional details regarding formation of the HRI coating 204 are described with reference to FIG. 6.

Returning now to FIGS. 1A-1C, the IRF segment 100 can be fabricated to have various lengths. By way of non-limiting example, the length of the IRF segment 100 can be about 1 micrometer (μm), about 10 μm, about 50 μm, from about 10 μm to about 100 μm, or from about 100 μm to about 1000 μm. Generally, selecting the length can be based on the degree of bending needed, what materials are used, the range of acceptable signal loss (e.g., how much light power/intensity a designer can tolerate for a given application, focal length of the type or types of imaging lens 106 that is used, and so forth.

Additionally, the IRF segment 100 can be fabricated or formed to have specific optical properties. For example, as shown in FIG. 1A, the IRF segment 100 can be configured so that a distance from the input plane 108 to the imaging lens 106 is an object distance (OD) and a distance from the imaging lens 106 to the output plane 110 is an image distance (ID). In some examples, the imaging lens 106 is configured to have a focal length (FL) such that the sum of 1/OD and 1/ID is about 1/FL. In other examples, FL can be from about 98 percent of 1/FL to about 102 percent of 1/FL, from about 95 percent of 1/FL to about 105 percent of 1/FL, or substantially equal to 1/FL.

Further, in some example the imaging lens 106 can be a 1:1 (symmetric) focusing lens so that the focal length is the approximately the same on either side of the lens. In other cases, the lens may be asymmetric (e.g., 2:1 or 1:2, and so forth). If, however, the lens is not symmetric, adjacent IRF segments 100 may include an opposite ratio lens (if one lens is 2:1, the next lens would be 1:2). This can help to avoid progressively magnifying or de-magnifying the image at each adjacent input plane, which could eventually cause the loss of much or all relevant spatial information. As a general guideline, if the fiber is relatively more flexible, then shorter segments are better. Otherwise, longer segments for stiffer materials can be used.

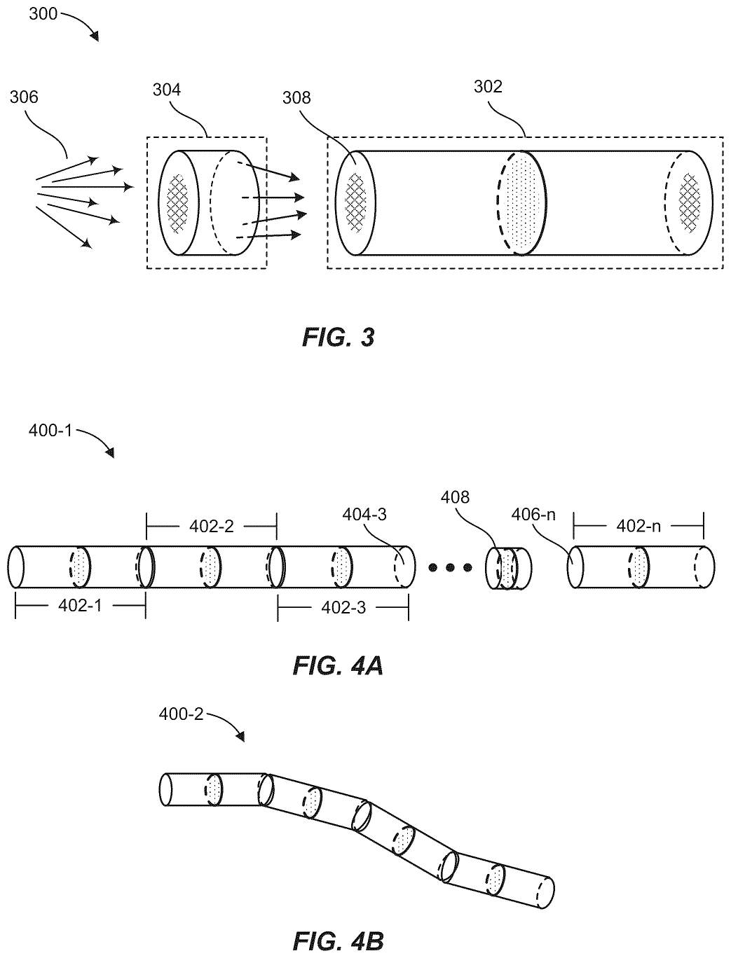

In some additional implementations, as shown in FIG. 3, another example IRF segment 300 can include an IRF segment 302 (which could be the IRF segment 100) and a pre-segment 304 that can be configured to focus light 306 at an input plane 308 of the IRF segment 300 (e.g., at an input plane of a first optical fiber subsegment of the IRF 300). The pre-segment 304 can be implemented as a variety of components. Non-limiting example implementations of the pre-segment 304 can include one or more of an optical lens, a flat lens, and an optical fiber (as shown in FIG. 3).

FIG. 4A illustrates an example segmented image-relay fiber (SIRF) 400-1. The SIRF 400-1 can include a plurality of image-relay fiber (IRF) segments 402. As shown in FIG. 4A, the SIRF 400-1 includes IRF segments 402-1 through 402-n. The plurality of IRF segments 402 can be implemented as, for example, any of the IRF segments of claims 1A-3 (e.g., IRF segments 100 or 300, or combinations of the IRF segments 100 and 300). In the example SIRF 400-1, respective output planes 404 at an output end of the IRF segments 402 are optically coupled with an input plane 406 of an adjacent IRF segment 402. For clarity in FIG. 4A, only output plane 404-3 and input plane 406-n are labeled. The respective output planes 404 can be optically coupled with the input planes 406 of the adjacent IRF segments 402 using any of a variety of techniques. Non-limiting example of the optical coupling techniques include optical glue, laser welding, spring joints, and sleeves (e.g., shrink-wrap tubes). Any approach that does not substantially degrade the light/image can be used. Regardless of the coupling technique used, such techniques can be chosen and performed so as to minimize or reduce losses across the coupling interface and can generally fill any contours or gaps between the lens and an adjacent fiber segment.

In some examples, the SIRF can be flexible at the optical coupling. Another example shown in FIG. 4B, SIRF 400-2 illustrates a SIRF with bends at the interfaces between output planes 404 and input planes 406 of an adjacent IRF segments 402. Overall flexibility can typically increase as the length of each IRF segment 402 decreases. Bendable fibers can be useful for biomedical applications like micro-endoscopy. The imaging lenses used with a flexible SIRF can be configured with an extended depth of focus, which can preserve image information even when the output/input image planes are slightly shifted from their ideal positions (due to, for example, bending, stretching, compression, or other deformations/strains).

In other implementations (not shown in FIG. 4A-B), multiple SIRFs 400-1 or 400-2 can be combined to create a composite multi-SIRF bundle. The multi-SIRF bundle can then be used to transfer images. Bundled SIRFs can be useful to transmit large quantities of images in parallel or to transmit images with larger quantities of pixels or images with larger fields-of-view than can be accommodated in a single SIRF.

In further examples, an image repeater 408 can be optically coupled between one or more of the coupled image-relay fiber segments 402 of the SIRF 400-1. The image repeater(s) 408 can be used to reduce attenuation of the signal-to-noise ratio (SNR) in the SRIF. In FIG. 4A, the image repeater 408 is shown optically coupled between IRF segments 402-(n-1) and IRF segment 402-n. As noted however, multiple image repeaters 408 can be implemented as necessary to maintain or modify image quality. The image repeater 408 can be realized in a variety of devices. Non-limiting examples of suitable image repeaters 408 include image recording devices (e.g., an image sensor with a lens), a display configured to receive and recreate the image that is to be received at the next input plane 406 (the display can be driven at a desired brightness with, for example, lasers or powered LED), and so forth.

Furthermore, in some implementations, the imaging lenses of each IRF segment 402 (e.g., any of the imaging lenses described with reference to FIGS. 1A-3, including the imaging lens 106) can be a same type of imaging lens. In other implementations, the imaging lenses can be different lens types (for clarity in FIG. 4A-B, the imaging lenses are not labeled).

FIGS. 1A through FIG. 4B describe several examples of image-relay fiber (IRF) segments and segmented image-relay fibers (SIRF). The different examples, however, can be understood as depicting various aspects of the IRF segments and SIRFs, which can be combined in full or in part. For example, some or all of the imaging lenses 106, 602, 806 can be realized as the same imaging lens. Similarly, other components, such as segments, subsegments, and so forth that are described or numbered differently in different figures can each be realized as the corresponding components in the other figures.

As a general guideline, the length of subsegments can range from about 10 μm to 1 cm, and in some cases about 20 μm to about 500 mm, and in other cases 20 μm to 2 mm. Further, a diameter of subsegments can generally range from about 5 μm to about 500 μm, in some cases 1 mm to 10 cm or more, and in other cases 2 mm to 5 cm, such as about 1 to 2 cm. Suitable diameters can be commensurate with the above lengths.

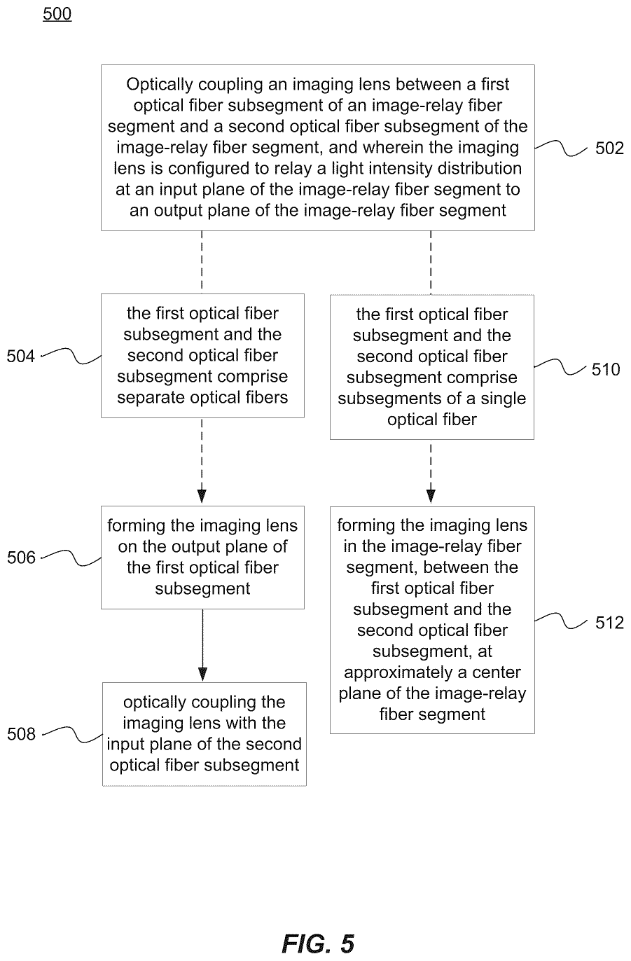

In addition to the image-relay fiber (IRF) segments and the segmented image-relay fibers (SIRF) described above, the present disclosure also describes methods of forming IRF segments and SIRFs. FIG. 5 is a flowchart illustrating an example method 500 of forming an image-relay fiber (IRF) segment. The method 500 can be implemented using some or all of the IRF and SIRF devices, features, and techniques described above with reference to FIG. 1A through FIG. 4B.

The method includes, at block 502, optically coupling an imaging lens between a first optical fiber subsegment of the image-relay fiber segment and a second optical fiber subsegment of the image-relay fiber segment. The imaging lens can be configured to relay a light intensity distribution at an input plane of the image-relay fiber segment to an output plane of the image-relay fiber segment. As described above, optical coupling can include one or more of coupling with optical glue, laser welding, coupling with spring joints, and coupling with sleeves (e.g., heat-shrink tubes).

In some non-limiting examples of the method 500, as described at block 504, the first optical fiber subsegment and the second optical fiber subsegment comprise separate optical fibers. The method continues at block 506, with forming the imaging lens on the output plane of the first optical fiber subsegment. At block 508, the method includes optically coupling the imaging lens with the input plane of the second optical fiber subsegment. Forming the imaging lens and optically coupling the imaging lens with the input plane of the second optical fiber subsegment can be performed using any of the techniques described with reference to FIG. 1A through FIG. 4.

In some other non-limiting examples of the method 500, as described at block 510, the first optical fiber subsegment and the second optical fiber subsegment comprise subsegments of a single optical fiber. At block 512, the method further comprises forming the imaging lens in the image-relay fiber segment, between the first optical fiber subsegment and the second optical fiber subsegment, at approximately a center plane of the image-relay fiber segment. Forming the imaging lens in the image-relay fiber segment, between the first optical fiber subsegment and the second optical fiber subsegment, can be performed using any of the techniques described with reference to FIG. 1A through FIG. 4

Furthermore, in some further examples of the method 500, the image-relay fiber segment includes an input plane that is at an end of the first optical fiber subsegment that is opposite the output plane of the first optical fiber subsegment and an output plane that is at an end of the second optical fiber subsegment that is opposite the input plane of the second optical fiber subsegment. In these examples, the method can further include forming the imaging lens such that the imaging lens is configured to relay a light intensity distribution at the input plane of the image-relay fiber segment to the output plane of the image-relay fiber segment.

The method can also include forming the imaging lens such that a distance from the input plane of the image-relay fiber segment to the imaging lens is an object distance (OD) and a distance from the imaging lens to the output plane of the image-relay fiber segment is an image distance (ID). In such examples, the imaging lens can be configured to have a focal length (FL) such that the sum of 1/OD and 1/ID can have various values. Non-limiting examples values of the sum of 1/OD and 1/ID can include about 1/FL, from about 98 percent of 1/FL to about 102 percent of 1/FL, from about 95 percent of 1/FL to about 105 percent of 1/FL, or substantially equal to 1/FL.

In additional examples, the method 500 can include forming a high-refractive-index (HRI) coating over an output end of the imaging lens. The HRI coating can be used to help preserve imaging lens function when the IRF segments are joined together. In these examples, optically coupling the input plane of the second optical fiber subsegment with the imaging lens can further comprise optically coupling the input plane of the second optical fiber subsegment with the HRI coating of the imaging lens. In some cases that include the HRI coating, the method 500 further includes planarizing the HRI coating after the HRI coating is formed.

Consider FIG. 6, which illustrates example techniques 600 for forming the high-refractive-index (HRI) coating over an output end of the imaging lens. Such HRI coatings can generally be formed after patterning of the corresponding lens. An example technique 600-1 includes steps 600-1A through 600-1C. At step 600-1A, an imaging lens 602-1 is formed on (or patterned on or coupled with) a substrate 604-1. At step 600-1B, the HRI coating 606-1 is applied to the imaging lens 602-1. In some cases, the HRI coating 606-1 may have an uneven surface 608-1. In these cases, the HRI coating 606-1 can be planarized, as shown at step 600-1C. The planarized surface 610-1 can allow improved optical coupling between the imaging lens 602-1 and another fiber segment or subsegment. In one example, the HRI coating can be omitted so that an air-gap is present when the next fiber segment is connected.

Another example technique 600-2 includes steps 600-2A through 600-2C. At step 600-2A, an imaging lens 602-2 is formed on (or patterned on or coupled with) a substrate 604-2 with a sacrificial layer 612-2 between the imaging lens 602-2 and the substrate 604-2. At step 600-2B, the HRI coating 606-2 is applied to the imaging lens 602-2. At step 600-2C, another substrate 614-2 is bonded to the HRI coating 606-2 over the imaging lens 602-2. The sacrificial layer 612-2 is then dissolved, leaving the imaging lens 602-2 available to be optically coupled with another fiber segment or subsegment (not shown). While not shown in the other example technique 600-2, the HRI coating 606-2 may also be planarized if it has an uneven surface. As described with reference to FIGS. 2A and 2B, the HRI coating 606-1 or 606-2 can be made from various suitable materials including polymer glass, silicon nitride, aluminum nitride, spin-on glass, and flowable polymers. Although planarization can be accomplished using any suitable technique, non-limiting examples of planarization techniques can include chemical mechanical polishing, manual polishing, automatic grit polishing, oxidation, chemical etching, etc.

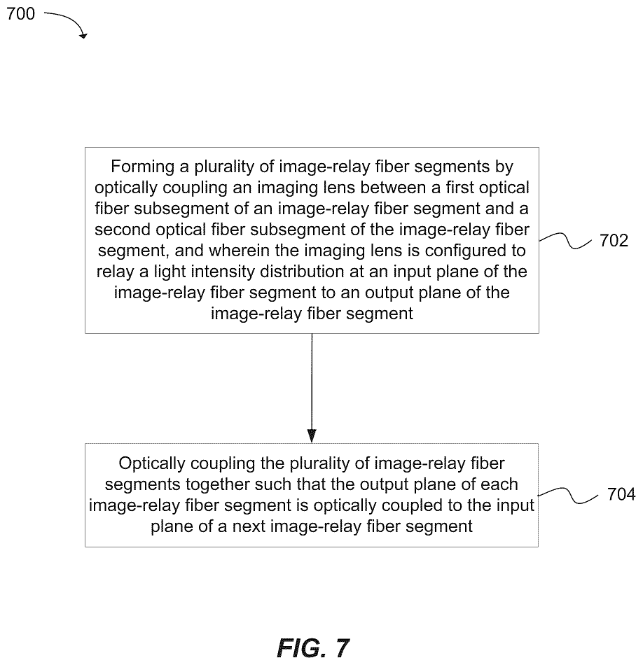

FIG. 7 is a flowchart illustrating an example method 700 of forming a segmented image-relay fiber (SIRF). The method 700 can be implemented using some or all of the IRF and SIRF devices, features, and techniques described above with reference to FIG. 1A through FIG. 6.

The method includes, at block 702, forming a plurality of image-relay fiber (IRF) segments. The IRF segments can be formed, for example, by optically coupling an imaging lens between a first optical fiber subsegment of an image-relay fiber segment and a second optical fiber subsegment of the image-relay fiber segment, and wherein the imaging lens is configured to relay a light intensity distribution at an input plane of the image-relay fiber segment to an output plane of the image-relay fiber segment.

The method also includes, at block 704, optically coupling the plurality of image-relay fiber segments together such that the output plane of each IRF segment is optically coupled to the input plane of a next IRF segment. As described above, optical coupling can include one or more of coupling with optical glue, laser welding, coupling with spring joints, and coupling with sleeves (e.g., heat-shrink tubes). Optionally, the method 700 can include coupling an image repeater between one or more of the coupled IRF segments.

A specific example implementation of the described apparatuses and methods is deep-tissue micro-endoscopy. This type of endoscopy can present unique challenges. For example, when transmitting information through a fiber, mixing between the spatial modes within the fiber can cause distorted images at the output plane. This distortion is influenced by fiber bends and dispersion. As described previously, multi-core fibers and fiber bundles can transmit undistorted images, however they suffer from low spatial resolution and large probe diameters. These factors can lead to tissue damage when imaging deep inside tissue, and gaps between cores or fibers can cause image artifacts.

One current micro-endoscopy technique uses a gradient-index (GRIN) rod lens for deep-tissue imaging. This technique can achieve relatively higher resolution beyond 1 mm depths. However, the technique faces two fundamental limitations. First, a limited field-of-view (FOV) less than 20 percent of the probe diameter and second, a decreasing FOV as the rod length increases for imaging deeper tissue. Proposed solutions to the FOV limitation, such as corrective microlenses, only provide modest improvements and can suffer from field-curvature aberrations. Adaptive optics, which scans focused spots through a multi-mode fiber, also has a low FOV/probe-diameter and is slower. Two-photon microscopy is non-invasive, but limited to imaging depths of about one millimeter (mm).

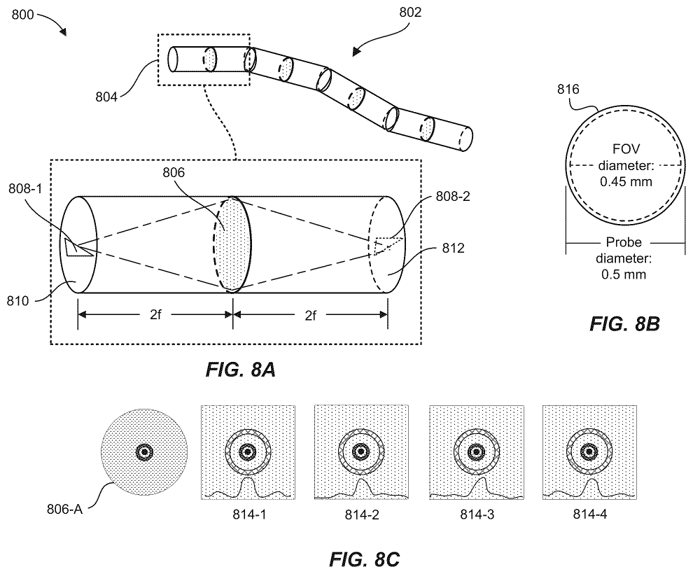

In contrast, FIG. 8A-C illustrates, generally at 800, aspects of a micro-endoscopy technology that uses the techniques described in this document, including IRF segments and SIRFs. Using this technology, sub-cellular resolution and wide field-of-view images can be captured from deep inside tissue via a SIRF-based micro-endoscope that includes one or more SIRFs 802. Each SIRF 802 includes multiple IRF segments 804 (including imaging lenses 806), connected together. FIG. 8A also illustrates one example IRF segment 804 to show additional details. The example IRF segment 804 depicts transfer of an image 808-1 from an input plane 810 of the IRF segment 804 to an output plane 812 of the IRF segment 804 (the transfer is shown by transferred image 808-2). The image transfer can be mediated by the imaging lens 806. In one non-limiting example, the imaging lens 806 can be an inverse-designed flat lens (e.g., diffractive or metalens). An inverse design can be used to correct aberrations (e.g., off-axis imaging, chromatic defects, curvature, etc.).

Some parameters for an example flat lens 806-A include a 150 μm diameter, a 100 um focal length, and a FOV from 0 degrees to 45 degrees, with a spot-size less than 1 μm. Some experimental data 814 using those parameters is recreated in FIG. 8C (the graphs and data are not to scale). As an example, FIG. 8C shows experimental data 814 depicts four point-spread function (PSF) graphs 814-1, 814-2, 814-3, and 814-4 that show a spot-size less than 1 micrometer over FOV 0-45 degrees (the incident angles are: 0, 9, 13.5, and 22.5, respectively). The flat lens can be fabricated using various technologies, as described in this document, including grayscale optical lithography, deposition of a high-refractive index (HRI) layer, and (optional) planarization.

The example micro-endoscopy technology described in FIG. 8A-C can also be used to enable less invasive imaging modalities with either a flexible or rigid probe. Further, the solution described in FIG. 8A can enable transfer of high-resolution images, with a lateral resolution of less than 10 μm, from greater depths within tissue, unlimited with endoscope length (e.g., more than 1 mm, more than 3 mm, or more than 5 mm). Additionally, in some implementations, the SIRF can achieve a FOV that covers more than 90% of the probe diameter. Consider one non-limiting example as shown in FIG. 8B in which a SIRF-based endoscopy probe 816 has a probe diameter of 0.5 millimeters (mm) and FOV diameter of 0.45 mm.

In some examples, the SIRF 802 can achieve sub-micrometer spatial resolution (e.g., about 0.5 μm diffraction limited with high-NA) at greater than one-centimeter (cm) tissue depth in a minimally invasive manner. The fiber diameter is kept less than or equal to about 200 μm, which limits the field-of-view of the microscope, but also ensures that the modality is minimally invasive (small incision).

Furthermore, customizable machine learning and linear algebraic methods for image processing can be specifically optimized for use with the SIRF. These methods can enhance the analysis and interpretation of the acquired images. SIRF can also enable researchers to visualize cellular structures beneath the skin or skull with remarkable detail would allow for the observation of fundamental life components in their natural context.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. An image-relay fiber segment, comprising:
a first optical fiber subsegment;
a second optical fiber subsegment, the second optical fiber subsegment optically coupled with the first fiber subsegment; and
an imaging lens optically coupled between the first optical fiber subsegment and the second optical fiber subsegment, the imaging lens configured to relay a light intensity distribution at an input plane of the image-relay fiber segment to an output plane of the image-relay fiber segment.

2. The image-relay fiber segment of claim 1, wherein the input plane and the output plane are at opposites ends of the image-relay fiber segment.

3. The image-relay fiber segment of claim 1, wherein the imaging lens comprises one or more of a diffractive lens, a multi-level diffractive lens, a metalens, a flat-lens, and a refractive lens.

4. The image-relay fiber segment of claim 1, wherein the imaging lens is made from one or more of germanium, glass, polymer, fused silica, titanium dioxide, and sapphire.

5. The image-relay fiber segment of claim 1, wherein:
the first optical fiber subsegment and the second optical fiber subsegment comprise separate optical fibers; and
the imaging lens is:
optically coupled with an end of the first optical fiber subsegment that is opposite the input plane; and
optically coupled with an end of the second optical fiber subsegment that is opposite the output plane.

6. The image-relay fiber segment of claim 1, wherein:
the first optical fiber subsegment and the second optical fiber subsegment comprise subsegments of a single optical fiber; and
the imaging lens is formed in the image-relay fiber segment, between the first optical fiber subsegment and the second optical fiber subsegment, at approximately a center plane of the image-relay fiber segment.

7. The image-relay fiber segment of claim 1, wherein:
a distance from the input plane to the imaging lens is an object distance (OD);
a distance from the imaging lens to the output plane is an image distance (ID); and
the imaging lens is configured to have a focal length (FL) such that a sum of 1/OD and 1/ID is:
about 1/FL;
from about 98 percent of 1/FL to about 102 percent of 1/FL;
from about 95 percent of 1/FL to about 105 percent of 1/FL; or substantially equal to 1/FL.

8. The image-relay fiber segment of claim 1, wherein the imaging lens includes a high-refractive-index (HRI) coating.

9. The image-relay fiber segment of claim 8, wherein the HRI coating comprises one or more of: a polymer glass; silicon nitride; aluminum nitride; spin-on glass; and a flowable polymer.

10. The image-relay fiber segment of claim 8, wherein the HRI coating is planarized.

11. The image-relay fiber segment of claim 1, wherein the image-relay fiber segment has a length of: about 1 micrometer (μm); about 10 μm; about 50 μm; from about 10 μm to about 100 μm; or from about 100 μm to about 1000 μm.

12. The image-relay fiber segment of claim 1, further comprising a pre-segment configured to focus light at an input plane of the first optical fiber subsegment.

13. The image-relay fiber segment of claim 12, wherein the pre-segment comprises one or more of: an optical lens; a flat lens; and an optical fiber.

14. A segmented image-relay fiber, comprising:
a plurality of image-relay fiber segments of claim 1, wherein respective output planes at an output end of the image-relay fiber segment are optically coupled with an input plane of an adjacent image-relay fiber segment.

15. The image-relay fiber segment of claim 14, wherein the respective output planes are optically coupled with the input planes of the adjacent image-relay fiber segments using one or more of: optical glue; laser welding; spring joints; and a sleeve.

16. The image-relay fiber segment of claim 14, wherein the imaging lens of the image-relay fiber segment and the imaging lens of the adjacent image-relay fiber segment are: a same lens type; or a different lens type.

17. A method of forming an image-relay fiber segment, comprising:
optically coupling an imaging lens between a first optical fiber subsegment of the image-relay fiber segment and a second optical fiber subsegment of the image-relay fiber segment, wherein the imaging lens is configured to relay a light intensity distribution at an input plane of the image-relay fiber segment to an output plane of the image-relay fiber segment.

18. The method of claim 17, wherein optically coupling comprises one or more of:
coupling with optical glue; laser welding; coupling with spring joints; and coupling with a sleeve.

19. The method of claim 17, wherein the first optical fiber subsegment and the second optical fiber subsegment comprise separate optical fibers; and the method further comprises:
forming the imaging lens on the output plane of the first optical fiber subsegment; and
optically coupling the imaging lens with the input plane of the second optical fiber subsegment; or
the first optical fiber subsegment and the second optical fiber subsegment comprise subsegments of a single optical fiber; and
the method further comprises:
forming the imaging lens in the image-relay fiber segment, between the first optical fiber subsegment and the second optical fiber subsegment, at approximately a center plane of the image-relay fiber segment.

20. The method of claim 19, further comprising forming the imaging lens using one or more of: a lithography technique; a diamond-turning technique; an injection molding technique; a nanoimprinting technique; and a microprinting technique.

21. The method of claim 20, wherein the lithography technique comprises one or more of: optical lithography; optical-projection lithography; two-photon lithography; multi-photon lithography; optical-grayscale lithography; scanning-electron-beam lithography; and focused-ion-beam lithography.

22. The method of claim 19, wherein:
the image-relay fiber segment includes:
an input plane that is at an end of the first optical fiber subsegment that is opposite the output plane of the first optical fiber subsegment; and
an output plane that is at an end of the second optical fiber subsegment that is opposite the input plane of the second optical fiber subsegment, and
the method further comprises:
forming the imaging lens such that:
the imaging lens is configured to relay a light intensity distribution at the input plane of the image-relay fiber segment to the output plane of the image-relay fiber segment;
a distance from the input plane of the image-relay fiber segment to the imaging lens is an object distance (OD); and
a distance from the imaging lens to the output plane of the image-relay fiber segment is an image distance (ID); and wherein the imaging lens is configured to have a focal length (FL) such that a sum of 1/OD and 1/ID is: about 1/FL, from about 98 percent of 1/FL to about 102 percent of 1/FL, from about 95 percent of 1/FL to about 105 percent of 1/FL, or substantially equal to 1/FL.

23. The method of claim 17, further comprising:
forming a high-refractive-index (HRI) coating over an output end of the imaging lens, and wherein:
optically coupling an input plane of a second optical fiber subsegment with the imaging lens further comprises optically coupling the input plane of the second optical fiber subsegment with the HRI coating of the imaging lens.

24. The method of claim 23, further comprising planarizing the HRI coating after the HRI coating is formed.

25. The method of claim 17, further comprising:
forming a plurality of image-relay fiber segments; and
optically coupling the plurality of image-relay fiber segments together such that the output plane of each image-relay fiber segment is optically coupled to the input plane of a next image-relay fiber segment.

26. The method of claim 25, further comprising optically coupling an image repeater between one or more of the coupled image-relay fiber segments.
